(19) United States
(12) Patent Application Publication
(10) Pub. No.: US 2010/0128611 A1
(43) Pub. Date: May 27, 2010

(54) TRANSMITTING APPARATUS, ALARM CONTROL METHOD, AND COMPUTER PRODUCT

(75) Inventor: Masaki DEGUCHI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/611,334

(22) Filed: Nov. 3, 2009

(30) Foreign Application Priority Data
Nov. 21, 2008 (JP) 2008-298587

(51) Int. Cl. H04L 12/26; G08B 21/00

(52) U.S. Cl. 370/242; 340/635

(57) ABSTRACT

Upon detecting the occurrence of a fault in a path that includes the transmitting apparatus, a transmitting apparatus transmits fault information including information about the fault to an initial node in the path corresponding to the fault. Upon receipt of the fault information, a transmitting apparatus determines whether an alarm is generated by a plurality of nodes due to the fault. Having determined that the alarm is generated due to the fault, the transmitting apparatus communicates a message including alarm masking information that suppresses the alarm with a terminal node via an intermediate node included in the path. Upon receipt of the message including the alarm masking information, a transmitting apparatus performs masking control so that an alarm is not to be issued to the management device connected thereto based on the alarm masking information.

### CROSS-REFERENCE TO RELATED APPLICATION

This application is based upon and claims the benefit of priority of the prior Japanese Patent Application No. 2008-298587, filed on Nov. 21, 2008, the entire contents of which are incorporated herein by reference.

### FIELD

The embodiments discussed herein are directed to a transmitting apparatus, an alarm control method, and a computer product.

### BACKGROUND

If some fault such as a path fault occurs in a network including a plurality of transmitting apparatuses (nodes), a transmitting apparatus near the fault occurrence location detects loss of signal (LOS) indicating no-signal state. The transmitting apparatus having detected the fault (LOS) transmits an alarm indication signal (AIS) to a transmitting apparatus located downstream of the path in which the fault has been detected. The AIS is a signal indicating that a fault occurs upstream of the path in which the transmitting apparatus that receives the AIS is located.

The transmitting apparatus having detected a fault (LOS) transmits a remote defect indication (RDI) to a transmitting apparatus located upstream of the path in which the fault has been detected. The RDI is a signal indicating that a fault occurs downstream of the path in which the transmitting apparatus that receives the RDI is located. The transmitting apparatus that receives a signal such as an AIR or an RDI further transmits the AIR or the RDI to a different transmitting apparatus.

An alarm that is generated when a fault is detected according to a conventional technology will be described with reference to FIG. 19. FIG. 19 is a diagram for explaining an alarm that is generated when a fault is detected according to a conventional technology. The term “alarm” as used herein refers to a notification of a fault issued to a management device or the like that manages a network including transmitting apparatuses that transmit data.

As depicted in FIG. 19, in nodes A to E as transmitting apparatuses that transmit data, if a fault occurs between the sending side S of the node B and the receiving side R of the node C, the node C (more specifically, the receiving side R thereof) detects LOS. The node C notifies a management device (not depicted) that manages the network including the nodes A to E that LOS is detected (see (1) in FIG. 19).

Then, the node C transmits a path-alarm indication signal (P-AIS) to the node D located downstream of the node C, and transmits a line-remote defect indication (L-RDI) to the node B located upstream thereof (see (2) in FIG. 19). The P-AIS transmitted by the node C to the node D is further transmitted to the node E that terminates the P-AIS (see (2) in FIG. 19).

Then, the nodes D and E that detect the P-AIS transmitted by the node C notify the management device of an alarm that the P-AIS is detected (see (3) in FIG. 19). The node B that detects the L-RDI transmitted by the node C notifies the management device of an alarm that the L-RDI is detected (see (3) in FIG. 19).

The node E that terminates the P-AIS generates a path-remote defect indication (P-RDI) and transmits the P-RDI to the node D located upstream of the node E (see (4) in FIG. 19). The P-RDI transmitted by the node E to the node D is further transmitted to the node A that terminates the P-RDI via the nodes C and B (see (5) in FIG. 19).

Then, the nodes D, C, B, and A that detect the P-RDI transmitted by the node E notify the management device of an alarm that the P-RDI is detected (see (6) in FIG. 19). That is, an alarm is generated by each of a plurality of transmitting apparatuses in a certain path when one LOS is detected.

Alarms in the entire network according to the conventional technology will be described with reference to FIG. 20. FIG. 20 is a diagram for explaining alarms in the entire network according to a conventional technology.

As depicted in FIG. 20, the entire network is formed of networks such as an add drop multiplexer (ADM) network and a wavelength division multiplexing (WDM) network, and is signal communicable by setting a path in end-to-end from the initial node to the terminal node. An ADM network and a WDM network are configured so that each thereof is grouped into a group (such as “NE Group 1” and “NE Group 2”) and each group has a plurality of nodes (transmitting apparatuses: network elements (NEs)) depicted in FIG. 19.

For example, when a LINE fault (LOS) occurs in an NE Group 3, an AIS, an RDI, and the like occur in end-to-end in all the paths set in the LINE. Each transmitting apparatus included in each NE Group notifies the management device that manages the entire network of an alarm that an AIS, an RDI, and the like are detected. Thus, a huge number of AISs, RDIs, and alarms occur in the entire network.

Recently, multi-protocol label switching (MPLS) is used in which a network is capable of being operated according to paths by introducing concept of a label in an IP network. Generalized multi-protocol label switching (GMPLS) is available in which not only an IP network but also a path network such as a time division multiplexing (TDM) network and a wavelength division multiplexing (WDM) network in Synchronous Digital Hierarchy (SDH)/Synchronous Optical Network (SONET) that is an international standard for a high speed digital communication system using an optical fiber is autonomously and dispersively operated. The GMPLS technology is currently being discussed in the Common Control and Measurement Plane (CCAMP) Working Group (WG) in the Internet Engineering Task Force (IETF), the Optical Internetworking Forum (OIF), and the International Telecommunication Union (ITU), and is being standardized. Moreover, a part of the GMPLS technology is being commercialized.

Recommendations such as the RFC3473 (Generalized Multi-Protocol Label Switching (GMPLS) Signaling Resource ReserVation Protocol-Traffic Engineering (RSVP-TE) Extensions) and the RFC4783 (GMPLS-Communication of Alarm Information) in the IETF provide a rule that controls an alarm in paths managed under the GMPLS.

Processes in which an alarm is controlled under the GMPLS management will be described with reference to FIG. 21. FIG. 21 is a diagram for explaining alarm control processes performed at the time of path setup under the GMPLS management according to a conventional technology. In the example of FIG. 21, a transmitting apparatus A as the initial node, transmitting apparatuses B and C as intermediate nodes, and a transmitting apparatus D as the terminal node are included in a path under the GMPLS management.

As depicted in FIG. 21, for example, when creating (signaling) a path to the transmitting apparatus D, the transmitting apparatus A transmits to the transmitting apparatus B by using a monitoring line (not depicted) a path message in which information such as routing information (ERO: Explicit_Route object) between the transmitting apparatuses A to D and a path number (TDM: time slot WDM (wavelength division multiplexing)) used between the transmitting apparatuses A and B (see (1) in FIG. 21).

The transmitting apparatus B that receives the path message puts the path number in reserved state, and performs control (alarm mask) under which the management device is not to be notified of an alarm when the specified path number is valid (unused), and then, transmits the path message to the transmitting apparatus C (see (2) in FIG. 21). Subsequently, the transmitting apparatus C that receives the path message performs a similar process performed by the transmitting apparatus B, and then, transmits the path message to the transmitting apparatus D (see (2) in FIG. 21).

Then, when the path message is valid, the transmitting apparatus D that receives the path message transmits to the transmitting apparatus C by using the monitoring line (not depicted) a reserve message that is a response message for the path message that is valid, and then, performs path setup (setup for a cross-connect) for the transmitting apparatus D (see (3) in FIG. 21).

The transmitting apparatus C that receives the reserve message transmits the reserve message to the transmitting apparatus B, and performs path setup for the transmitting apparatus C according to the path number put in reserved state when the path message is received (see (4) in FIG. 21). Subsequently, the transmitting apparatus B that receives the reserve message performs a similar process performed by the transmitting apparatus C, and then, transmits the reserve message to the transmitting apparatus A (see (4) in FIG. 21).

The transmitting apparatus that receives the reserve message performs path setup for the transmitting apparatus, and thus, path setup is completed from the transmitting apparatus A to the transmitting apparatus D.

A plurality of objects (fields) is assigned to the path message as depicted in FIG. 22, and an A bit is specified (Admin Down specification) in an ADMIN_STATUS object (see FIG. 23) when an alarm masking process is performed.

In summary, a transmitting apparatus that receives a path message performs alarm masking control when an A bit is specified in an ADMIN_STATUS object assigned to the path message. FIG. 22 is a diagram of an example of objects assigned to a path message. FIG. 23 is a schematic of an ADMIN_STATUS object in detail.

Objects depicted in FIG. 24 are assigned to a reserve message that is a response message for a path message. The contents of the path message and the reserve message are depicted in FIGS. 25A and 25B. FIG. 24 is a diagram of an example of objects assigned to a reserve message. FIG. 25A is a diagram of main objects assigned to a path message, and FIG. 25B is a diagram of main objects assigned to a reserve message.

Thus, an alarm may occur, for example, due to modifying setup for a cross-connect in each of the transmitting apparatuses located in the initial, the intermediate, and the terminal points of a path when path setup is performed. Such an alarm is naturally expected to occur, and therefore, alarm masking is preliminarily performed in each transmitting apparatus so that alarm notification to a management device is suppressed.

Japanese Laid-open Patent Publication No. 11-284633 and Japanese Laid-open Patent Publication No. 06-350542 disclose conventional technologies related to call control.

With the conventional technology described above, however, a system administrator who operates a network bears a heavy load of maintenance work.

More specifically, a rule for controlling an alarm by a GMPLS function according to RFC3473, RFC4783, and the like is only for setting or deleting a path. Therefore, masking control cannot be performed during operation according to the rule.

For example, if a fault occurs in a path in which a plurality of transmitting apparatuses is located when masking control of an alarm is not performed, each transmitting apparatus transmits to a management device a fault detected thereby as an alarm. Then, the management device is notified of a huge number of alarms. Therefore, a load on a network used for notifying an AIS, an RDI, and an alarm thereto and load on the management device increase. A system administrator that manages a network is required to identify a fault that causes a huge number of alarms among the alarms thus generated to perform maintenance work. Therefore, a load on the system administrator also increases.

### SUMMARY

According to an aspect of the invention, a transmitting apparatus is connected to a management device that manages a network and transfers data. The transmitting apparatus includes a fault information notifying unit and an alarm control unit. When detecting occurrence of a fault in the network, the fault information notifying unit notifies an initial node in a path corresponding to the fault of fault information including information about the fault. When receiving a message communicated between the initial node having received the fault information from the fault information notifying unit and a terminal node, and including alarm masking information that prevents an alarm to notify the management device of occurrence of the fault from being issued to the management device, the alarm control unit controls the alarm not to be issued to the management device based on the alarm masking information.

According to another aspect of the invention, a transmitting apparatus is connected to a management device that manages a network and transfers data. The transmitting apparatus includes an alarm generation determining unit and a message transmitting/receiving unit. When detecting occurrence of a fault in the network or notified of information on occurrence of a fault from another transmitting apparatus, the alarm generation determining unit determines whether an alarm that notifies the management device of the occurrence of the fault is generated by a plurality of nodes in a path corresponding to the fault. When the alarm generation determining unit determines that the alarm is generated, the message transmitting/receiving unit communicates a message including alarm masking information that suppresses the alarm between the transmitting apparatus and a terminal node via an intermediate node in the path.

According to still another aspect of the present invention, there is provided an alarm control method applied to a transmitting apparatus that is connected to a management device that manages a network and transfers data. The alarm control method includes: notifying, upon detecting occurrence of a fault in the network, an initial node in a path corresponding to the fault of fault information including information about the fault; determining, when the initial node receives the fault information, whether an alarm that notifies the management device of the occurrence of the fault is generated by a plurality of nodes in the path corresponding to the fault; communicating, when it is determined that the alarm is generated at the determining, a message including alarm masking information that suppresses the alarm between the initial node and a terminal node via an intermediate node in the path; and controlling, upon receipt of the message, the alarm not to be issued to the management device based on the alarm masking information.

According to still another aspect of the present invention, a computer-readable recording medium stores therein a computer program that causes a computer to implement the above method.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example diagram for explaining an alarm control process according to a first embodiment of the present invention;

FIG. 2 is a configuration example of a transmitting apparatus C that is an intermediate node according to the first embodiment;

FIG. 3 is a configuration example of a transmitting apparatus A that is an initial node according to the first embodiment;

FIG. 4 is an example of objects assigned to a Notify Message;

FIG. 5 is an example the contents of an ERROR_SPEC object;

FIG. 6A is a configuration example of the ERROR_SPEC object in IPv4;

FIG. 6B is a configuration example of the ERROR_SPEC object in IPv6;

FIG. 6C is an example of the contents of each member of the ERROR_SPEC object;

FIG. 6D is an example schematic diagram for explaining how to use an Error Code;

FIG. 7 is an example sequence diagram of an alarm control process according to the first embodiment;

FIG. 8 is an example diagram for explaining an alarm control process performed by the transmitting apparatus according to a second embodiment of the present invention;

FIG. 9 is an example sequence diagram of the alarm control process according to the second embodiment;

FIG. 10 is an example sequence diagram of an alarm control process according to a third embodiment of the present invention;

FIG. 11 is an example sequence diagram of an alarm control process according to a fourth embodiment of the present invention;

FIG. 12 is a configuration example of the ADMIN_STATUS object according to the fourth embodiment;

FIG. 13 is an example diagram for explaining an alarm control process performed by the transmitting apparatus according to a fifth embodiment of the present invention;

FIG. 14 is an example sequence diagram of the alarm control process according to the fifth embodiment;

FIG. 15 is an example diagram for explaining an alarm control process performed by the transmitting apparatus according to a sixth embodiment of the present invention;

FIG. 16 is an example sequence diagram of the alarm control process according to the sixth embodiment;

FIG. 17 is an example diagram of a computer that executes an alarm control program;

FIG. 18 is an example diagram of a computer that executes a message transmitting/receiving program;

FIG. 19 is a diagram for explaining an alarm that is generated when a fault is detected according to a conventional technology;

FIG. 20 is a diagram for explaining an alarm in the entire network according to a conventional technology;

FIG. 21 is a diagram for explaining the alarm control process at the time of path setup under the GMPLS management according to a conventional technology;

FIG. 22 is an example of objects assigned to a path message;

FIG. 23 is a schematic of an ADMIN_STATUS object in detail;

FIG. 24 is a diagram of an example of objects assigned to a reserve message;

FIG. 25A is a diagram of the contents of main objects assigned to a path message; and

FIG. 25B is a diagram of the contents of main objects assigned to a reserve message.

### DESCRIPTION OF EMBODIMENTS

Exemplary embodiments of the invention will be explained with reference to the accompanying drawings.

### [a] First Embodiment

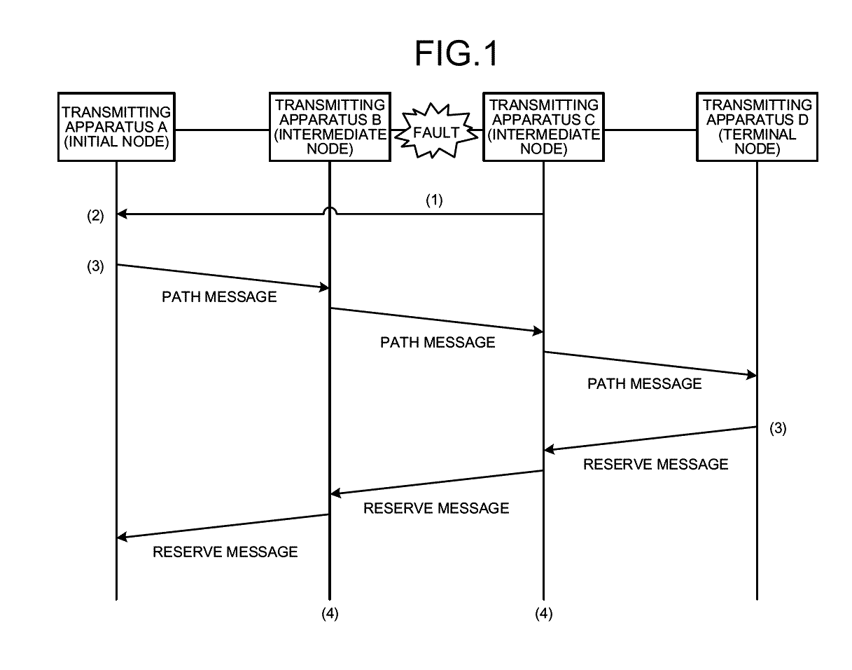

An alarm control process performed by a transmitting apparatus according to a first embodiment of the present invention will be described with reference to FIG. 1. FIG. 1 is a diagram for explaining the alarm control process performed by the transmitting apparatus according to the first embodiment.

As depicted in FIG. 1, the entire network includes, for example, transmitting apparatuses A, B, C, and D. A path is formed so that the transmitting apparatus A is an initial node, the transmitting apparatuses B and C are intermediate nodes, and the transmitting apparatus D is a terminal node.

In the following, the transmitting apparatuses A to D will be described as being connected to a management device (not depicted) that manages a network formed of nodes, and having GMPLS functions to transfer data (such as a path message and a reserve message). Each transmitting apparatus having the GMPLS function holds information (path information) about the adjacent nodes connected to the transmitting apparatus. The information is collected by using link management protocol (LMP) functions.

Transmitting apparatuses that constitute a path are not limited to the transmitting apparatuses A to D. The path may be formed of less than four or equal to or more than five transmitting apparatuses. The transmitting apparatus A may be connected to a transmitting apparatus other than the transmitting apparatus B, and the transmitting apparatus A that is the initial node may be an intermediate node or a terminal node in the path including the transmitting apparatuses A to D.

In the configuration described above, when a transmitting apparatus detects that a fault occurs in the network, the transmitting apparatus notifies the initial node in a path corresponding to the fault of fault information including information about the fault detected thereby.

More specifically, as indicated by (1) in FIG. 1, the transmitting apparatus C detects LOS (no-signal state) when a fault occurs in the path between the sending side of the transmitting apparatus B and the receiving side of the transmitting apparatus C. The transmitting apparatus C transmits fault information (a Notify Message) including information about the fault (LOS) detected thereby to the transmitting apparatus A that is the initial node in the path corresponding to the fault.

When a transmitting apparatus detects that a fault occurs in the network or is notified of information about a fault that occurs in another transmitting apparatus, the transmitting apparatus determines whether an alarm that notifies the management device of occurrence of the fault is generated by a plurality of nodes in the path corresponding to the fault.

More specifically in the example described above, when the transmitting apparatus A detects LOS due to occurrence of a fault similarly to the transmitting apparatus C described above or when the transmitting apparatus A is notified of information about a fault detected by the transmitting apparatus C, as indicated by (2) in FIG. 1, the transmitting apparatus A determines whether an alarm is generated by a plurality of nodes (such as the transmitting apparatuses B and C in FIG. 1).

Whether an alarm is generated due to a fault can be determined according to the contents of objects included in fault information (a Notify Message). A Notify Message will be described in detail with the configuration of a transmitting apparatus described later.

Then, a transmitting apparatus sends and receives messages including alarm masking information that suppresses an alarm between the transmitting apparatus and the terminal node via the intermediate nodes included in the path when it is determined that an alarm is generated.

More specifically in the example described above, when it is determined that an alarm is generated due to a fault, the transmitting apparatus A sends and receives messages including alarm masking information that suppresses the alarm (an A bit is specified in the ADMIN_STATUS object) between the transmitting apparatus A and the transmitting apparatus D that is the terminal node via the transmitting apparatuses B and C that are the intermediate nodes included in the path, as indicated by (3) in FIG. 1.

The messages sent and received to and from the transmitting apparatuses A and D via the transmitting apparatuses B and C is a path message (sent by the transmitting apparatus A) and a reserve message (sent by the transmitting apparatus D in response thereto) according to GMPLS functions. The path message and the reserve message of the first embodiment are not used for modifying setup of a cross-connect, but is used for alarm control of the transmitting apparatuses in the path of which setup is already completed (i.e., in operation).

Upon receipt of a message that is communicated between the initial node having received the fault information thus sent and the terminal node and that includes alarm masking information for suppressing an alarm to notify the management device of occurrence of a fault, the transmitting apparatus performs masking control so that an alarm is not to be issued to the management device according to the alarm masking information.

More specifically in the example described above, when the transmitting apparatus C receives a reserve message that includes alarm masking information (i.e., the A bit is specified in the ADMIN_STATUS object) as indicated by (4) in FIG. 1, the transmitting apparatus C performs control (masking control) according to the alarm masking information so that the management device is not to be notified of an alarm. The transmitting apparatus B performs the similar process performed by the transmitting apparatus C, and performs control under which the management device is not to be notified of an alarm.

Incidentally, alarm masking control is described above as not being performed in the transmitting apparatus A as the initial node and the transmitting apparatus D as the terminal node. This is because the transmitting apparatuses A and D notify the management device of an fault that actually occurs. In other words, when alarm masking control is performed in the transmitting apparatuses A and D, it may be configured so that alarm masking control is not performed in the transmitting apparatus C that detects the fault.

In general, the transmitting apparatus A that receives fault information from the transmitting apparatus C performs operation under which path setup is performed by using a new route avoiding the fault location, thereby switching routes. The process, however, is a known technology, and will not be described herein.

As described above, when an alarm is generated due to a fault in the network, the transmitting apparatus performs masking control of the alarm. Therefore, a load of maintenance work on the system administrator that operates the network can be reduced.

In other words, because the transmitting apparatus performs masking control of an alarm that is generated due to a fault in the network, concentration of alarms on the management device that manages the network can be prevented. Therefore, a load on the entire network can be reduced. The transmitting apparatus prevents concentration of alarms on the management device and notifies the management device only of an alarm necessary for system maintenance. Therefore, a load of maintenance work on the system administrator that operates the network can be reduced.

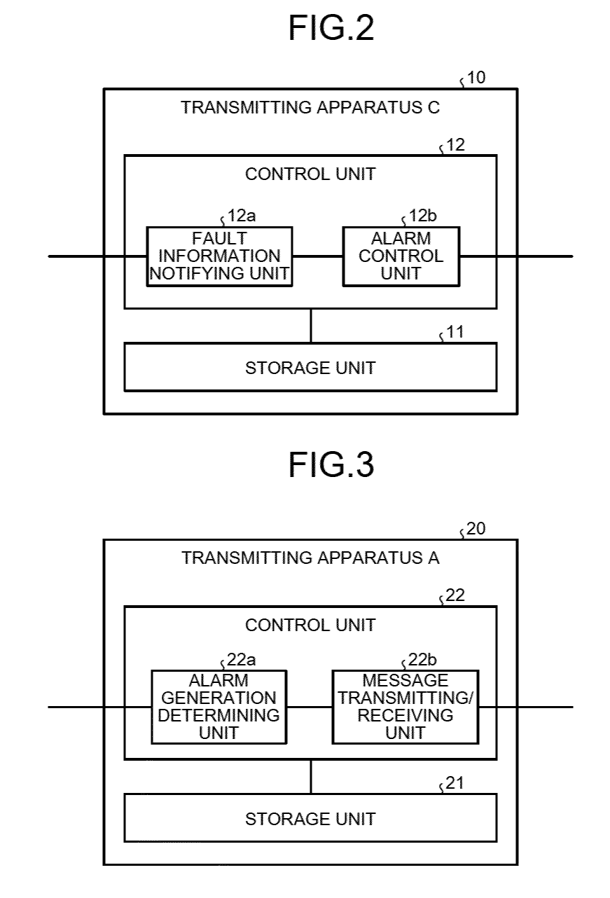

An example of the configuration of the transmitting apparatus according to the first embodiment will be described in detail with reference to FIGS. 2 and 3. FIG. 2 is a diagram of an example of the configuration of the transmitting apparatus C that is an intermediate node according to the first embodiment. FIG. 3 is a diagram of an example of the configuration of the transmitting apparatus A that is an initial node according to the first embodiment.

As depicted in FIG. 2, a transmitting apparatus C10 includes a storage unit 11 and a control unit 12. The transmitting apparatus C10 is, for example, connected to a management device that manages a network formed of nodes, and performs data transmission with a transmitting apparatus other than the transmitting apparatus C10. Below, the transmitting apparatus C10 is included in a path in which the transmitting apparatus A that is the initial node, the transmitting apparatus B that is the intermediate node, and the transmitting apparatus D that is the terminal node are located.

The storage unit 11 stores therein data necessary for various processes performed by the control unit 12 and various results of the processes performed by the control unit 12. The storage unit 11 stores therein, for example, information of a path of which setup is already completed and that is collected with LMP functions of GMPLS. The path information stored by the storage unit 11 includes, for example, an ID of the local node and an IP address of the local node as information about the transmitting apparatus, a Link ID of the local node, an ID of the opposing node, an IP address of the opposing node, and a Link ID of the opposing node as Link information, a receiving Link ID, a receiving channel, a transmitting Link ID, a transmitting channel, and a bandwidth as cross-connect information.

The control unit 12 includes an internal memory that stores therein a control program, a computer program that prescribes various processing procedures, and necessary data. In particular, the control unit 12 includes a fault information notifying unit 12a and an alarm control unit 12b, and performs various processes therewith.

When a fault that occurs in the network is detected, the fault information notifying unit 12a notifies the initial node in the path corresponding to the fault of fault information including information about the fault thus detected.

More specifically, the fault information notifying unit 12a detects LOS when a fault occurs in the path between the sending side of the transmitting apparatus B and the receiving side of the transmitting apparatus C10. The fault information notifying unit 12a transmits fault information (a Notify Message) including the fault (LOS) thus detected to the transmitting apparatus A that is the initial node in the path corresponding to the fault.

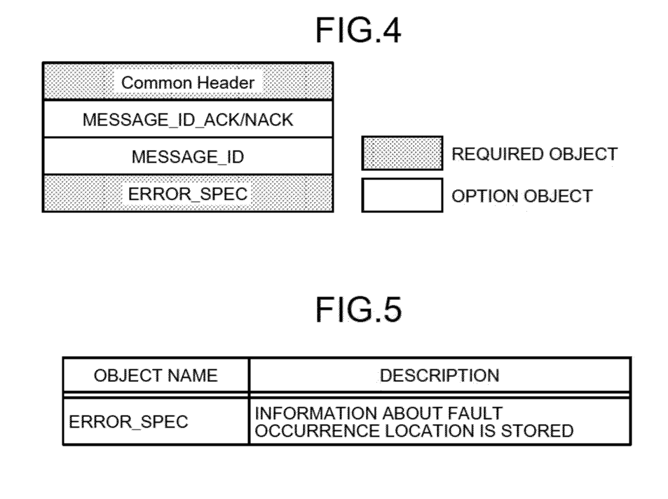

Objects depicted in FIG. 4 are assigned to the Notify Message transmitted to the transmitting apparatus, and information about the location at which the fault thus detected is stored in an ERROR_SPEC object as depicted in FIG. 5. FIG. 4 is a diagram of an example of the contents of the objects assigned to the Notify Message, and FIG. 5 is a diagram of the contents of the ERROR_SPEC object.

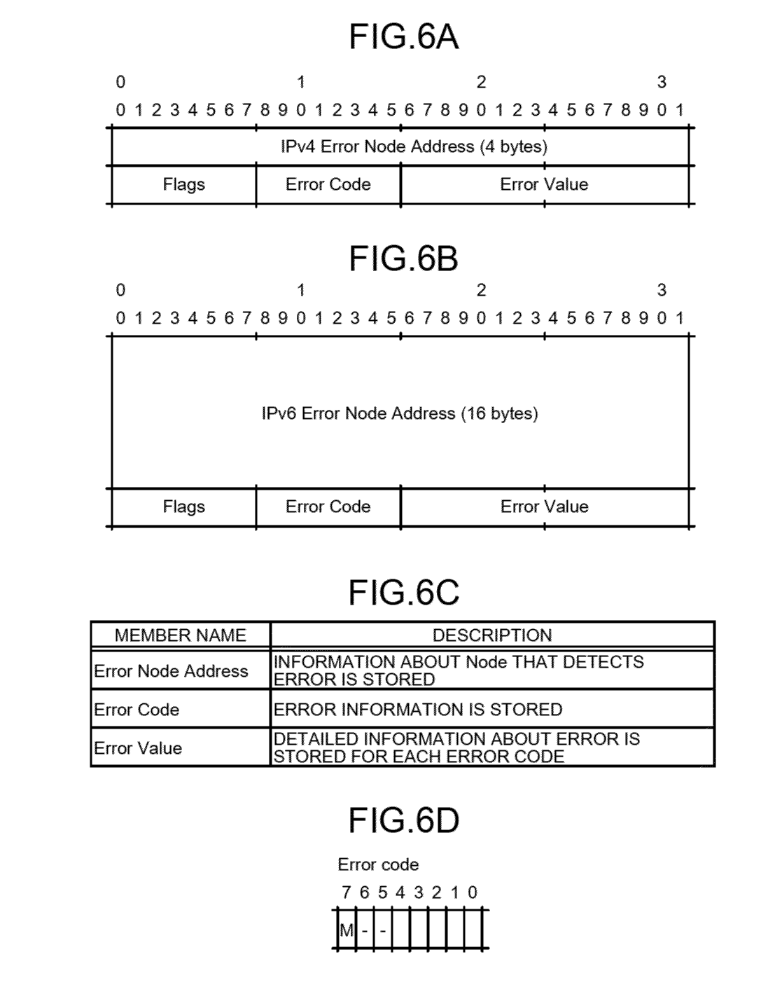

Configuration of the ERROR_SPEC object will be described with reference to FIGS. 6A and 6B. FIG. 6A is a schematic of a configuration example of the ERROR_SPEC object in IPv4. FIG. 6B is a schematic of a configuration example of the ERROR_SPEC object in IPv6.

The ERROR_SPEC object includes, for example, an Error Node Address in which information is stored about a node in which an error is detected, an Error Code in which error information is stored, and an Error Value in which detailed information is stored about the error according to the Error Code, as depicted in FIGS. 6A and 6B. The contents of each member of the ERROR_SPEC object are depicted in FIG. 6C.

A specification of the Error Code is defined in RFC2205, and the values of which the specification is specified are 0 to 23. 9 to 11 and 15 to 19 among 0 to 23 of which the specification is defined are reserved values. Therefore, 3 most significant bits are unused field as depicted in FIG. 6D. FIG. 6D is a schematic for explaining how to use the Error Code.

When an alarm is generated due to a fault, a flag is set at the most significant bit (i.e., the section “M” depicted in FIG. 6D) in the Error Code. Occurrence of an alarm may be assigned to a certain number of the Error Code. Flags or the Error Value may be used when an alarm is generated. Because unused field are used, general information of the Error Code (0 to 23) can be conventionally transmitted. In summary, notification that an alarm is generated due to a fault is performed by using not only the Error Code but also the unused fields of the ERROR_SPEC object.

When the alarm control unit 12b receives a message that is communicated between the initial node that receives the fault information sent by the fault information notifying unit 12a and the terminal node and that includes alarm masking information that suppresses an alarm that notifies the management device of occurrence of a fault, the alarm control unit 12b performs masking control under which the management device is not to be notified of an alarm according to the alarm masking information.

More specifically in the example described above, when the alarm control unit 12b receives a message that is communicated between the initial node that receives a fault information (for example, a flag is set on an Error Code of the ERROR_SPEC object) sent by the fault information notifying unit 12a and the terminal node and that includes alarm masking information (the A bit is specified in the ADMIN_STATUS object), the alarm control unit 12b performs control (masking control) according to the alarm masking information so that the management device is not to be notified of an alarm.

As depicted in FIG. 3, the transmitting apparatus A20 includes a storage unit 21 and a control unit 22. The transmitting apparatus A20 is, for example, connected to the management device that manages a network formed of nodes, and performs data transmission with a transmitting apparatus other than the transmitting apparatus A20. Below, the transmitting apparatus A20 is included in a path in which the transmitting apparatuses B and C that are intermediate nodes, and the transmitting apparatus D that is the terminal node are located.

The storage unit 21 stores therein data necessary for various processes performed by the control unit 22 and various results of the processes performed by the control unit 22. The storage unit 21 stores therein, for example, information of a path of which setup is completed and that are collected with LMP functions of GMPLS. The path information stored by the storage unit 21 includes, for example, the ID of the local node and the IP address of the local node as information about the transmitting apparatus, the Link ID of the local node, the ID of the opposing node, the IP address of the opposing node, and the Link ID of the opposing node as Link information, the receiving Link ID, the receiving channel, the transmitting Link ID, the transmitting channel, and the bandwidth as cross-connect information.

The control unit 22 includes an internal memory that stores therein a control program, a computer program that prescribes various processing procedures, and necessary data. In particular, the control unit 22 includes an alarm generation determining unit 22a and a message transmitting/receiving unit 22b, and performs various processes therewith.

When the alarm generation determining unit 22a detects that a fault occurs in the network or is notified of information about a fault that occurs in another transmitting apparatus, the alarm generation determining unit 22a determines whether an alarm that notifies the management device of occurrence of the fault is generated by a plurality of nodes in the path corresponding to the fault.

More specifically, for example, when the alarm generation determining unit 22a detects LOS due to occurrence of a fault similarly to the transmitting apparatus C10 described above or when the alarm generation determining unit 22a is notified of information about a fault detected by the transmitting apparatus C10, the alarm generation determining unit 22a determines whether an alarm is generated by a plurality of nodes.

Whether an alarm is generated due to a fault can be determined, for example, by determining whether a flag is set on an Error Code of the ERROR_SPEC object included in fault information (a Notify Message) sent from the transmitting apparatus C10.

Then, the message transmitting/receiving unit 22b sends and receives messages including alarm masking information that suppresses an alarm between the transmitting apparatus and the terminal node via the intermediate nodes included in the path when the alarm generation determining unit 22a determines that an alarm is generated.

More specifically in the example described above, when it is determined that an alarm is generated due to a fault, the message transmitting/receiving unit 22b sends and receives messages including alarm masking information that suppresses the alarm (i.e., the A bit is specified in the ADMIN_STATUS object) between the transmitting apparatus A20 and the transmitting apparatus D that is the terminal node via the transmitting apparatuses B and C10 that are intermediate nodes included in the path.

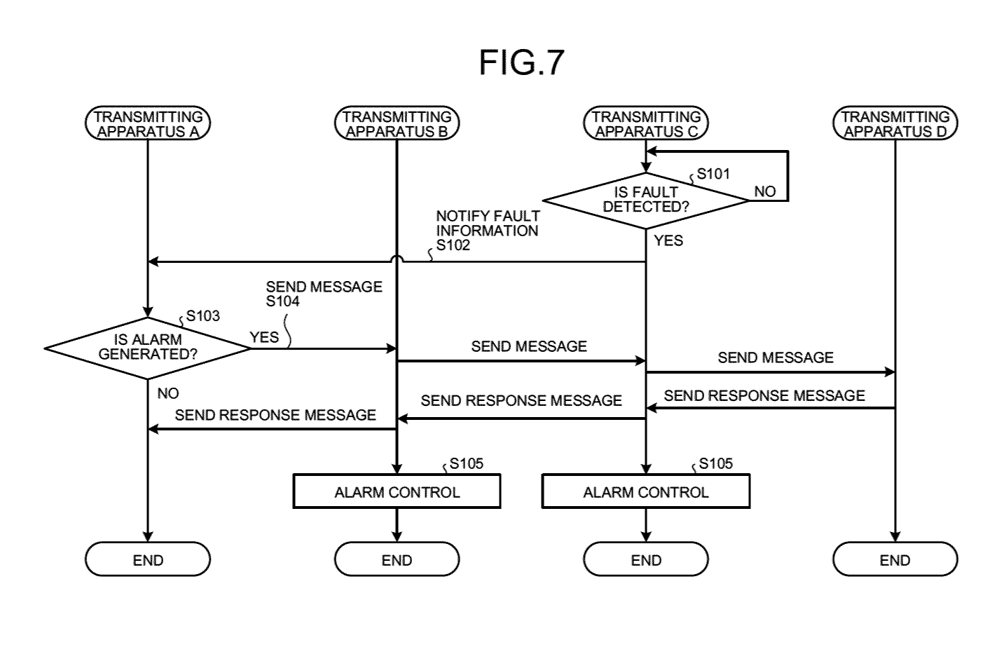

A flow of an alarm control process according to the first embodiment will be described with reference to FIG. 7. FIG. 7 is a sequence diagram of the alarm control process according to the first embodiment.

As depicted in FIG. 7, for example, if the transmitting apparatus C10 detects LOS due to occurrence of a fault in the path between the sending side of the transmitting apparatus B and the receiving side of the transmitting apparatus C10 (Yes at Step S101), the transmitting apparatus C10 transmits fault information (a Notify Message, in which a flag is set on the most significant bit of the Error Code of the ERROR_SPEC object) including information about the fault (LOS) thus detected to the transmitting apparatus A20 that is the initial node in the path corresponding to the fault (Step S102).

When the transmitting apparatus A20 is notified of information about the fault detected by the transmitting apparatus C10 (i.e., the notify message), the transmitting apparatus A20 determines whether an alarm that notifies the management device of occurrence of a fault is generated by a plurality of nodes according to whether a flag is set on the Error Code of the ERROR_SPEC object (Step S103).

If it is determined that the alarm is generated due to a fault (Yes at Step S103), the transmitting apparatus A20 sends and receives messages including alarm masking information that suppresses the alarm (i.e., the A bit is specified in the ADMIN_STATUS object) between the transmitting apparatus A20 and the transmitting apparatus D that is the terminal node via the transmitting apparatuses B and C10 that are the intermediate nodes included in the path (Step S104).

When the transmitting apparatus C10 receives a reserve message that includes alarm masking information (i.e., the A bit is specified in the ADMIN_STATUS object), the transmitting apparatus C10 performs control (masking control) according to the alarm masking information so that the management device is not to be notified of an alarm (Step S105). Similarly to the transmitting apparatus C10, when the transmitting apparatus B receives the reserve message, the transmitting apparatus B performs control (masking control) under which the management device is not to be notified of an alarm (Step S105).

As described above, according to the first embodiment, the transmitting apparatus detects a fault in the network and controls (masking control) an alarm that may be issued to the management device from each transmitting apparatus. Therefore, a load of maintenance work on the system administrator that operates the network can be reduced.

For example, when the transmitting apparatus C10 detects that a fault occurs in a path, the transmitting apparatus C10 transmits fault information including information about the fault thus detected (a Notify Message) to the transmitting apparatus A20 that is the initial node in the path that corresponds to the fault. When the transmitting apparatus C10 notifies the transmitting apparatus A20 of the fault information, the transmitting apparatus A20 determines whether an alarm is generated by a plurality of nodes. When it is determined that the alarm is generated due to a fault, the transmitting apparatus A20 sends and receives messages including alarm masking information that suppresses the alarm (i.e., the A bit is specified in the ADMIN_STATUS object) between the transmitting apparatus A20 and the transmitting apparatus D that is the terminal node via the transmitting apparatuses B and C10 that are the intermediate nodes included in the path. When the transmitting apparatus C10 receives a reserve message including alarm masking information (i.e., the A bit is specified in the ADMIN_STATUS object), the transmitting apparatus C10 performs control (masking control) according to the alarm masking information so that the management device is not to be notified of an alarm. The transmitting apparatus B performs the similar process performed by the transmitting apparatus C10, and performs control under which the management device is not to be notified of an alarm. As a result, the transmitting apparatus can reduce a load of maintenance work on the system administrator that operates the network.

### [b] Second Embodiment

In the first embodiment, an example is described in which when a fault is detected in a path, the initial node is notified of the fault to control an alarm for the management device. However, it is not so limited. For example, when a fault is detected in a path, an arbitrary node may be notified of the fault, and thereby an alarm for the management device may be controlled.

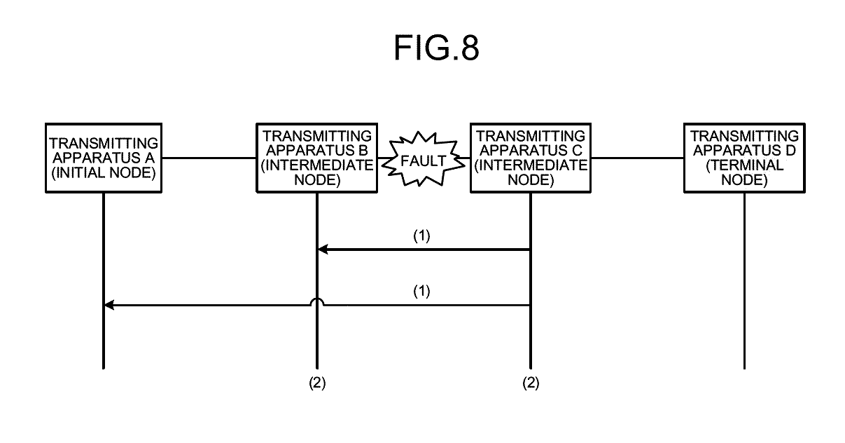

In the following, an alarm control process performed by a transmitting apparatus according to a second embodiment of the present invention will be described with reference to FIG. 8. FIG. 8 is a diagram for explaining the alarm control process performed by the transmitting apparatus according to the second embodiment. The configuration and functions of the transmitting apparatus of the second embodiment are basically similar to those previously described in the first embodiment, and therefore their description will not be repeated.

As depicted in FIG. 8, when the transmitting apparatus detects that a fault occurs in the network, the transmitting apparatus notifies an arbitrary node in the path corresponding to the fault of fault information including information about the fault detected thereby.

More specifically, as indicated by (1) in FIG. 8, the transmitting apparatus C10 detects LOS when a fault occurs in the path between the sending side of the transmitting apparatus B and the receiving side of the transmitting apparatus C10. The transmitting apparatus C10 transmits fault information (a Notify Message) including information about the fault (LOS) detected thereby to an arbitrary node (such as the transmitting apparatuses A20 and B) located in the path corresponding to the fault.

In the fault information transmitted to the transmitting apparatuses A20 and B, for example, a flag is set on the most significant bit in the Error Code that is an unused field of the ERROR_SPEC object.

A destination of the Notify Message (any node can be a destination thereof) can be identified by registering an address of the transmitting apparatus (each device) in a path message at the time of path setup and in a Notify Request object in a reserve message. Each transmitting apparatus can determine a route from the initial node to the terminal node according to an EXPLICIT_ROUTE object and the like. Therefore, a Notify Message can be transmitted to a node even if the node is not notified by the Notify Request object.

According to fault information that is notified by a node that detects that a fault has occurred in the network, the transmitting apparatus performs control so that the management device is not to be notified of an alarm that notifies the management device of occurrence of a fault.

More specifically in the example described above, the transmitting apparatus B performs control (masking control) according to the fault information notified by the transmitting apparatus C10 so that the management device is not to be notified of an alarm as indicated by (2) in FIG. 8. The transmitting apparatus C10 that detects the fault performs control (masking control) under which the transmitting apparatus does not notify the management device of an alarm.

In the example described above, masking control of an alarm is not performed in the transmitting apparatus A20 that is notified of the fault information. Similarly to the first embodiment, however, masking control of an alarm may be performed not in the transmitting apparatus C10, but in the transmitting apparatus A20.

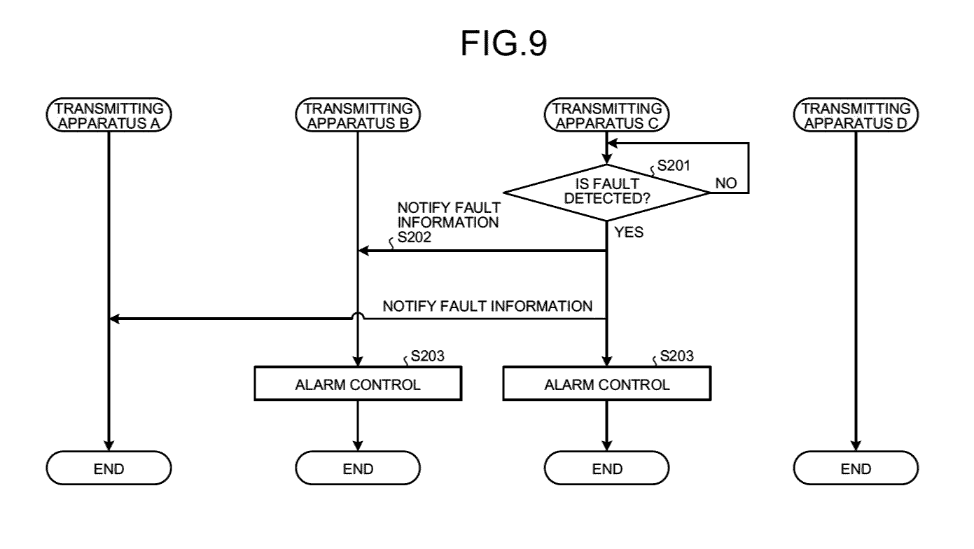

A flow of the alarm control process according to the second embodiment will be described with reference to FIG. 9. FIG. 9 is a sequence diagram for explaining a flow of the alarm control process according to the second embodiment.

As depicted in FIG. 9, for example, if the transmitting apparatus C10 detects LOS due to occurrence of a fault in the path between the sending side of the transmitting apparatus B and the receiving side of the transmitting apparatus C10 (Yes at Step S201), the transmitting apparatus C10 transmits fault information (a Notify Message, in which a flag is set on the most significant bit of the Error Code of the ERROR_SPEC object) including information about the fault (LOS) thus detected to an arbitrary node (such as the transmitting apparatuses A20 and B) in the path corresponding to the fault (Step S202).

The transmitting apparatus B performs control (masking control) according to the fault information notified by the transmitting apparatus C10 so that the management device is not to be notified of an alarm (Step S203). The transmitting apparatus C10 that detects the fault performs control (masking control) so that the transmitting apparatus C10 does not notify the management device of an alarm (Step S203).

As described above, according to the second embodiment, when the transmitting apparatus detects a fault in the network, the transmitting apparatus notifies an arbitrary node of information about the fault. The transmitting apparatus that is notified of the fault performs control so that the management device is not to be notified of an alarm. As a result, the transmitting apparatus can flexibly sets up a node in which masking control of an alarm is performed and a node which notifies the management device of an alarm according to load condition of the network and the like.

That is, the transmitting apparatus performs making control of an alarm in a node connected to a network continuously under a high load, and notifies the management device of an alarm in a node connected to a network continuously under a low load. Therefore, the transmitting apparatus can control an alarm according to condition of the network to which the transmitting apparatus is connected. The transmitting apparatus can more quickly perform masking control of an alarm for the management device.

### [c] Third Embodiment

In the first embodiment described above, an example is described in which an alarm for the management device is controlled based on the messages communicated between initial and terminal nodes. However, it is not so limited. In each transmitting apparatus, an alarm may be controlled not to be generated until control of an alarm based on the messages communicated between initial and terminal nodes is completed.

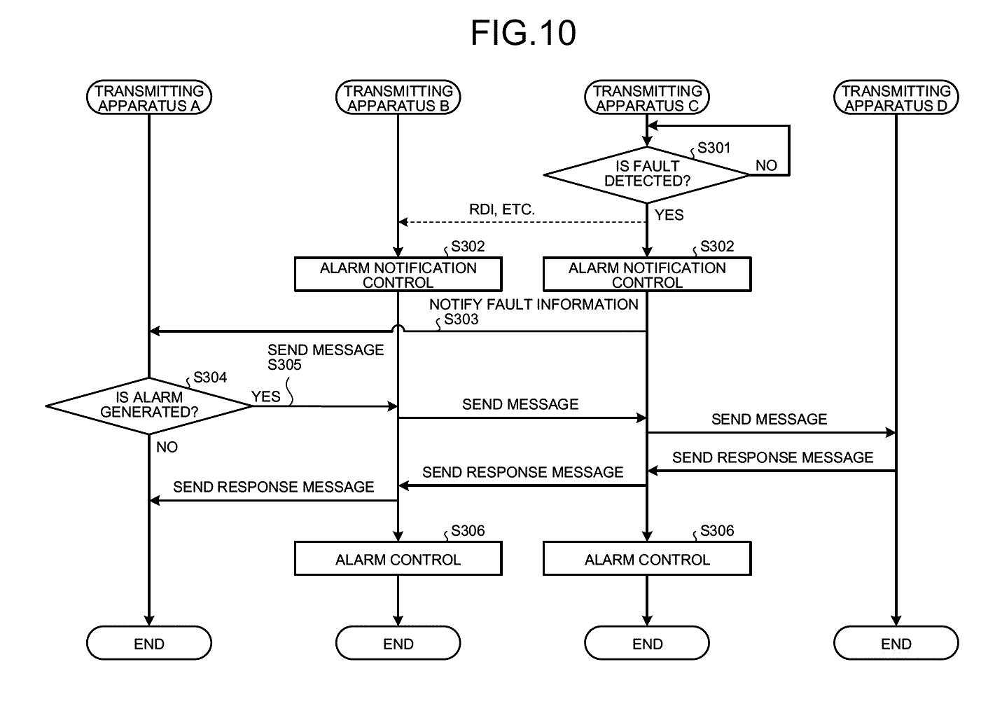

In the following, a flow of an alarm control process according to a third embodiment of the present invention will be described with reference to FIG. 10. FIG. 10 is a sequence diagram of the alarm control process according to the third embodiment. The configuration and functions of the transmitting apparatus of the third embodiment are basically similar to those described previously in the first embodiment, and therefore their description will not be repeated.

For example, as depicted in FIG. 10, if the transmitting apparatus C10 detects LOS when a fault occurs in the path between the sending side of the transmitting apparatus B and the receiving side of the transmitting apparatus C10 (Yes at Step S301), the transmitting apparatus C10 performs control under which an alarm is not generated until an alarm is controlled not to be issued to the management device (Step S302).

If the transmitting apparatus C10 detects a fault, the transmitting apparatus C10 transmits an RDI and the like to the transmitting apparatus B. Therefore, the transmitting apparatus B performs control under which an alarm is controlled not to be generated until an alarm is controlled not to be issued to the management device (Step S302).

Then, the transmitting apparatus C10 transmits fault information including information about the fault (LOS) (a Notify Message, in which a flag is set on the most significant bit of the Error Code of the ERROR_SPEC object) to the transmitting apparatus A20 that is the initial node in the path corresponding to the fault (Step S303).

When the transmitting apparatus A20 is notified of information about the fault detected by the transmitting apparatus C10 (i.e., the Notify Message), the transmitting apparatus A20 determines whether an alarm that notifies the management device of occurrence of a fault is generated by a plurality of nodes according to whether a flag is set on the Error Code of the ERROR_SPEC object (Step S304).

If it is determined that the alarm is generated due to a fault (Yes at Step S304), the transmitting apparatus A20 transmits and receives messages including alarm masking information that suppresses the alarm (i.e., the A bit is specified in the ADMIN_STATUS object) between the transmitting apparatus A20 and the transmitting apparatus D that is the terminal node via the transmitting apparatuses B and C10 that are the intermediate nodes included in the path (Step S305).

When the transmitting apparatus C10 receives a reserve message that includes the alarm masking information (i.e., the A bit is specified in the ADMIN_STATUS object), the transmitting apparatus C10 performs control (masking control) according to the alarm masking information so that the management device is not to be notified of an alarm (Step S306). Similarly to the transmitting apparatus C10, when the transmitting apparatus B receives the reserve message, the transmitting apparatus B performs control (masking control) under which the management device is not to be notified of an alarm (Step S306).

The control process of an alarm performed at Step S302 may be performed in each transmitting apparatus before the transmitting apparatus C10 detects a fault. When a node which notifies the management device of an alarm is decided in advance, however, the node cannot notify the management device of an alarm unless it receives an AIS or an RDI. Therefore, the control process of an alarm is preferably performed after an AIS or an RDI is transmitted.

In summary, when it is decided in advance that the transmitting apparatus B notifies the management device of an alarm, if the control process of an alarm performed at Step S302 is performed in the transmitting apparatuses B and C10 before the transmitting apparatus C10 detects a fault, the management device cannot be notified of an alarm because the transmitting apparatus B cannot receive an AIS or an RDI. Therefore, the control process of an alarm is preferably performed after an AIS or an RDI is transmitted.

As described above, according to the third embodiment, the transmitting apparatus performs control so that each transmitting apparatus does not issue an alarm to the management device until the masking process of an alarm performed based on the messages communicated between initial and terminal nodes is completed. Thus, an alarm that may be generated before the masking control of an alarm performed based on the messages communicated between initial and terminal nodes is completed can be suppressed. Thus, a load on the network can be reduced.

In other words, the transmitting apparatus performs control so that an alarm issued to the management device according to an AIS or an RDI transmitted to each transmitting apparatus when a fault is detected is not issued to the management device until the masking control of an alarm performed according to the messages communicated between initial and terminal nodes is completed. Thus, a load on the network can be reduced.

### [d] Fourth Embodiment

In the first embodiment described above, an example is described in which, according to whether the alarm is generated due to a fault, the masking control of an alarm is performed by each transmitting apparatus located in the path corresponding to the fault. However, it is not so limited. Information may be stored in each transmitting apparatus as to whether an alarm is issued, and masking control of an alarm is (or is not) performed accordingly.

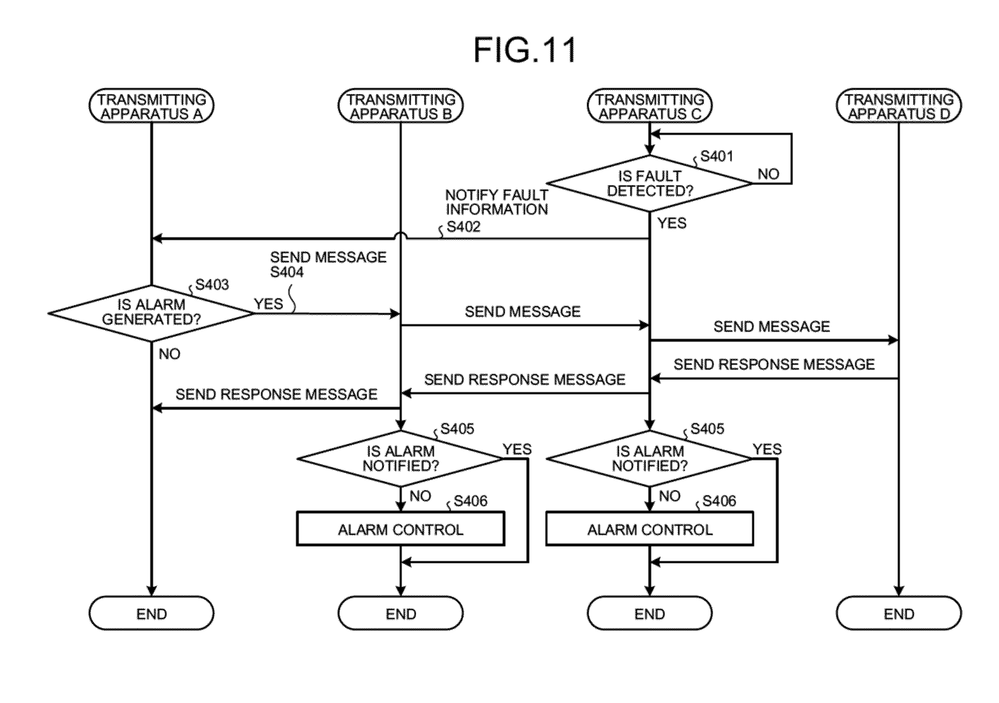

In the following, a flow of an alarm control process according to a fourth embodiment of the present invention will be described with reference to FIG. 11. FIG. 11 is a sequence diagram of the alarm control process according to the fourth embodiment. The configuration and functions of the transmitting apparatus of the fourth embodiment are basically similar to those described previously in the first embodiment, and therefore their description will not be repeated.

More specifically, the transmitting apparatus stores therein alarm notifying information about whether an alarm is issued to the management device, and controls whether to issue an alarm to the management device according to the alarm masking information and the alarm notifying information. The alarm notifying information indicates whether an alarm is “issued” or “not issued” to the management device.

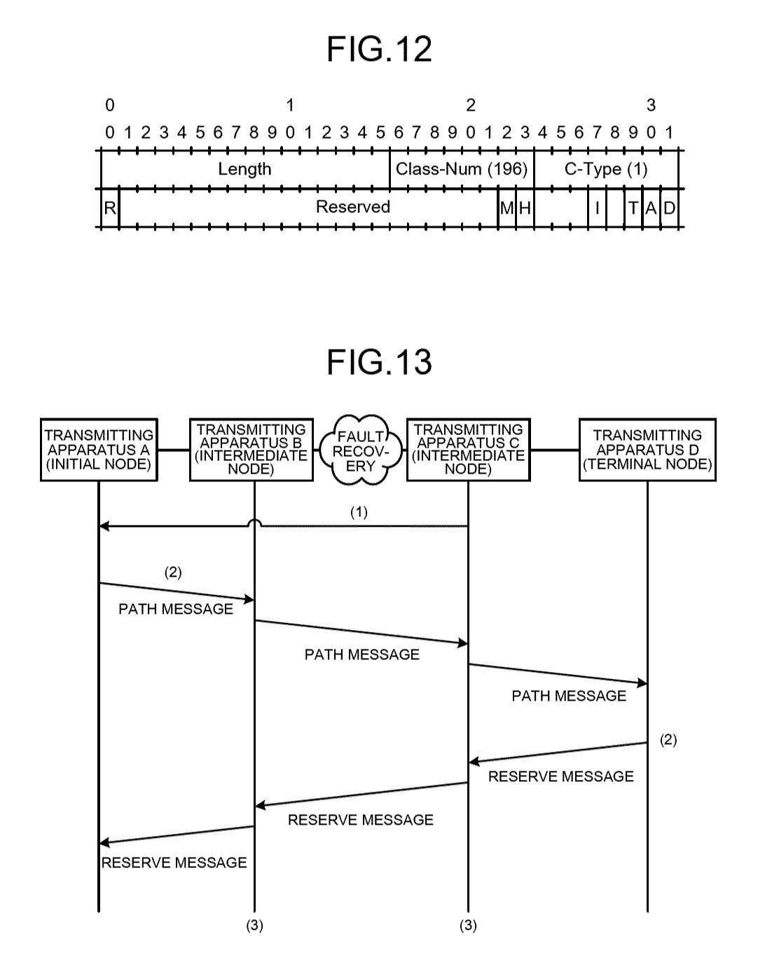

For example, when each transmitting apparatus decides whether the masking control of an alarm is performed, as depicted in FIG. 12, a flag in a reserved field of the ADMIN_STATUS object (for example, the “H” bit field depicted in FIG. 12) is used. FIG. 12 is a schematic of a configuration example of the ADMIN_STATUS object according to the fourth embodiment.

For example, as depicted in FIG. 11, if the transmitting apparatus C10 detects LOS due to occurrence of a fault in the path between the sending side of the transmitting apparatus B and the receiving side of the transmitting apparatus C10 (Yes at Step S401), the transmitting apparatus C10 transmits fault information (a Notify Message, in which a flag is set on the most significant bit of the Error Code of the ERROR_SPEC object) including information about the fault (LOS) thus detected to the transmitting apparatus A20 that is the initial node in the path corresponding to the fault (Step S402).

When the transmitting apparatus A20 is notified of information about the fault detected by the transmitting apparatus C10 (i.e., the Notify Message), the transmitting apparatus A20 determines whether an alarm that notifies the management device of occurrence of a fault is generated by a plurality of nodes according to whether a flag is set on the Error Code of the ERROR_SPEC object (Step S403).

If it is determined that the alarm is generated due to a fault (Yes at Step S403), the transmitting apparatus A20 sends and receives the messages including alarm masking information that suppresses the alarm (i.e., the H bit is specified in the ADMIN_STATUS object) between the transmitting apparatus A20 and the transmitting apparatus D that is the terminal node via the transmitting apparatuses B and C10 that are the intermediate nodes included in the path (Step S404).

When the transmitting apparatus C10 receives a reserve message including the alarm masking information (i.e., the H bit is specified in the ADMIN_STATUS object), the transmitting apparatus C10 determines whether to issue an alarm to the management device according to the alarm masking information and the alarm notifying information stored in the storage unit indicating whether an alarm is issued to the management device (Step S405).

If it is determined that an alarm is issued to the management device (Yes at Step S405), the transmitting apparatus C10 notifies the management device of the alarm. If it is determined that an alarm is not issued to the management device (No at Step S405), the transmitting apparatus C10 performs control (masking control) under which the management device is not to be notified of an alarm (Step S406).

As with the transmitting apparatus C10, if it is determined that an alarm is issued to the management device (Yes at Step S405), the transmitting apparatus B notifies the management device of the alarm. If it is determined that an alarm is not issued to the management device (No at Step S405), the transmitting apparatus B performs control (masking control) under which the management device is not to be notified of an alarm (Step S406).

As described above, according to the fourth embodiment, each transmitting apparatus stores therein alarm notifying information as to whether each transmitting apparatus notifies the management device of an alarm, and performs control whether to issue an alarm to the management device according to the alarm notifying information and the alarm masking information included in the messages communicated between initial and terminal nodes. Therefore, a load on the network can be reduced by, for example, deciding a transmitting apparatus which notifies the management device of an alarm according to processing condition of the network.

That is, the transmitting apparatus decides whether each transmitting apparatus performs masking control of an alarm when the messages communicated between initial and terminal nodes are received. Therefore, a load on the network due to performing masking control of an alarm can be reduced. As a result, the transmitting apparatus can reduce a load on the (entire) network, and can flexibly setup a node which notifies the management device of an alarm according to load condition of the network and the like.

### [e] Fifth Embodiment

In the first to the fourth embodiments described above, examples are described in which masking control is performed of an alarm that is generated when a fault occurs in the network. However, it is not so limited. The masking control thus performed may be cancelled when the fault in the network is recovered.

In the following, an alarm control process performed by the transmitting apparatus according to a fifth embodiment of the present invention will be described with reference to FIG. 13. FIG. 13 is a diagram for explaining the alarm control process performed by the transmitting apparatus according to the fifth embodiment. The configuration and functions of the transmitting apparatus of the fifth embodiment are basically similar to those described previously in the first embodiment, and therefore, their description will not be repeated.

As depicted in FIG. 13, when the transmitting apparatus detects that the fault is recovered in the network, the transmitting apparatus transmits fault recovery information including information about the fault recovery thus detected to the initial node in the path.

More specifically, as indicated by (1) in FIG. 13, the transmitting apparatus C10 detects that the fault occurring in the path between the sending side of the transmitting apparatus B and the receiving side of the transmitting apparatus C10 is recovered. Then, the transmitting apparatus C10 transmits fault recovery information including information about the fault recovery thus detected (a Notify Message) to the transmitting apparatus A20 that is the initial node in the path corresponding to the fault.

A destination of the Notify Message (any node can be a destination thereof) can be identified by registering the address of the transmitting apparatus (each apparatus) in a path message at the time of path setup and in a Notify Request object in a reserve message. Each transmitting apparatus can determine a route from the initial node to the terminal node according to an EXPLICIT_ROUTE object and the like. Therefore, the Notify Message can be transmitted to a node even if the node is not notified by the Notify Request object.

When the transmitting apparatus detects that the fault is recovered in the network or is notified of information about fault recovery that occurs in another transmitting apparatus, the transmitting apparatus determines whether the path under the masking control of an alarm due to the fault is under the GMPLS management. If the path is under the GMPLS management, the transmitting apparatus sends and receives messages including fault recovery information that indicates that the fault is recovered between the transmitting apparatus and the terminal node via the intermediate nodes included in the path.

More specifically in the example described above, as indicated by (2) in FIG. 13, similarly to the transmitting apparatus C10 described above, when the transmitting apparatus A20 detects that the fault is recovered or is notified of recovery information of a fault detected by the transmitting apparatus C10, the transmitting apparatus A20 determines whether the path under the masking control of the alarm due to the fault (i.e., the path in which the transmitting apparatuses B and C10 are located) is under the GMPLS management.

Then, if the path in which the transmitting apparatuses B and C10 are located is under the GMPLS management, the transmitting apparatus A20 sends and receives a message including the fault recovery information that indicates that the fault is recovered between the transmitting apparatus A20 and the transmitting apparatus D that is the terminal node via the transmitting apparatuses B and C10 that are the intermediate nodes included in the path.

When the transmitting apparatus receives a message that is communicated between the initial node that receives the fault recovery information and the terminal node and that includes the message including the fault recovery information, the transmitting apparatus cancels the control under which the management device is not to be notified of an alarm according to the fault recovery information.

More specifically in the example described above, as indicated by (3) in FIG. 13, when the transmitting apparatus C10 receives the reserve message including the fault recovery information, the transmitting apparatus C10 cancels the control (masking control) under which the management device is not to be notified of an alarm according to the fault recovery information. The transmitting apparatus B performs a similar process performed by the transmitting apparatus C10, and cancels the control (masking control) under which the management device is not to be notified of an alarm.

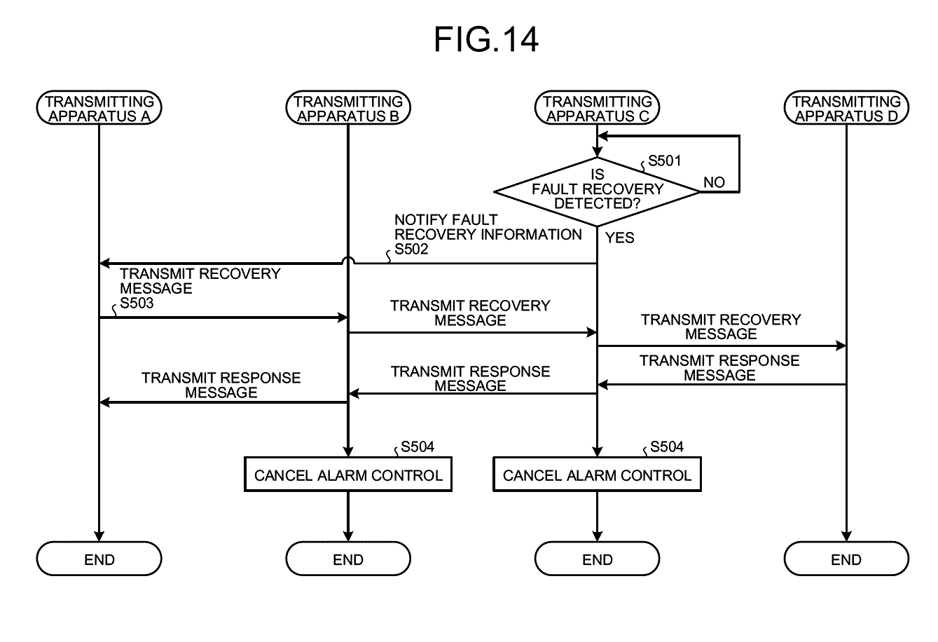

A flow of the alarm control process according to the fifth embodiment will be described with reference to FIG. 14. FIG. 14 is a sequence diagram of the alarm control process according to the fifth embodiment.

For example, as depicted in FIG. 14, if the transmitting apparatus C10 detects that the fault is recovered in the path between the sending side of the transmitting apparatus B and the receiving side of the transmitting apparatus C10 (Yes at Step S501), the transmitting apparatus C10 transmits fault recovery information that indicates that the fault thus detected is recovered to the transmitting apparatus A20 that is the initial node in the path corresponding to the fault (Step S502).

If the transmitting apparatus A20 is notified of recovery information about the fault detected by the transmitting apparatus C10, the transmitting apparatus A20 determines whether the path under the masking control of the alarm due to the fault is under the GMPLS management. If the path is under the GMPLS management, the transmitting apparatus A20 sends and receives a message including the fault recovery information between the transmitting apparatus A20 and the transmitting apparatus D that is the terminal node via the transmitting apparatuses B and C10 that are the intermediate nodes included in the path (Step S503).

If the transmitting apparatus C10 receives the reserve message including the fault recovery information, the transmitting apparatus C10 cancels the control (masking control) under which the management device is not to be notified of an alarm according to the fault recovery information (Step S504). The transmitting apparatus B performs the similar process performed by the transmitting apparatus C10, and cancels the control (masking control) under which the management device is not notified of an alarm.

As described above, according to the fifth embodiment, if a fault occurring in the network is recovered, the transmitting apparatus detects that the fault is recovered, and cancels the masking control of the alarm being performed. Therefore, for example, even if a fault occurs again therein, the management device can be notified of an alarm.

That is, if a fault occurring in the network is recovered, the transmitting apparatus can quickly cancel the alarm mask. As a result, the transmitting apparatus can notify the management device of an alarm even if a fault occurs again.

### [f] Sixth Embodiment

In the fifth embodiment described above, an example is described in which if the transmitting apparatus detects that a fault occurring in the path is recovered, the transmitting apparatus notifies the initial node of recovery information of the fault, and then, cancels the masking control under which the management device is not notified of an alarm. However, it is not so limited. If the transmitting apparatus detects that a fault occurring in the path is recovered, the transmitting apparatus may notify an arbitrary node of recovery information of the fault, and then cancel the masking control of an alarm for the management device.

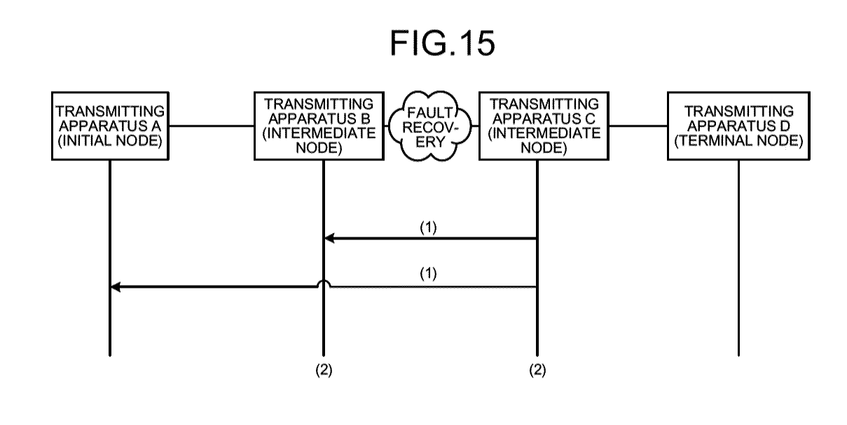

In the following, an alarm control process according to a sixth embodiment of the present invention will be described with reference to FIG. 15. FIG. 15 is a diagram for explaining the alarm control process performed by the transmitting apparatus according to the sixth embodiment. The configuration and functions of the transmitting apparatus of the sixth embodiment are basically similar to those described previously in the first embodiment, and therefore their description will not be repeated.

As depicted in FIG. 15, if the transmitting apparatus detects that a fault occurring in the network is recovered, the transmitting apparatus transmits fault recovery information including information about the fault recovery thus detected to an arbitrary node in the path.

More specifically, as indicated by (1) in FIG. 15, the transmitting apparatus C10 detects that the fault is recovered in the path between the sending side of the transmitting apparatus B and the receiving side of the transmitting apparatus C10. Then, the transmitting apparatus C10 transmits the fault recovery information including the recovery information of the fault thus detected to an arbitrary node in the path corresponding to the fault (such as the transmitting apparatuses A20 and B).

The transmitting apparatus cancels the control under which the management device is not to be notified of an alarm according to the fault recovery information notified by the node that detects that the fault is recovered in the network.

More specifically in the example described above, as indicated by (2) in FIG. 15, the transmitting apparatus B cancels the control (masking control) under which the management device is not to be notified of an alarm according to the fault recovery information notified by the transmitting apparatus C10. The transmitting apparatus C10 that detects that the fault is recovered cancels the control (masking control) under which the transmitting apparatus does not notify the management device of an alarm.

Here, the masking control is not cancelled in the transmitting apparatus A20 that is notified of the fault recovery. If the masking control is performed in the transmitting apparatus A20, however, the masking control is cancelled. As with the transmitting apparatus C10, if the masking control is performed in the transmitting apparatus D, the transmitting apparatus C10 notifies the transmitting apparatus D of fault recovery information, and thereby the masking control is cancelled.

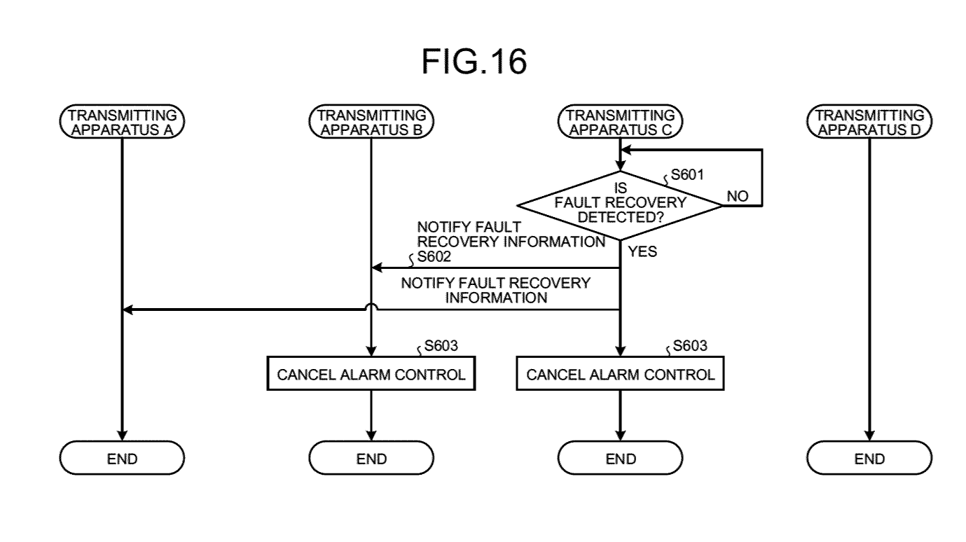

A flow of the alarm control process according to the sixth embodiment will be described with reference to FIG. 16. FIG. 16 is a sequence diagram of the alarm control process according to the sixth embodiment.

For example, as depicted in FIG. 16, if the transmitting apparatus C10 detects that the fault is recovered in the path between the sending side of the transmitting apparatus B and the receiving side of the transmitting apparatus C10 (Yes at Step S601), the transmitting apparatus C10 transmits fault recovery information including information about recovery information of the fault detected by the transmitting apparatus C10 to an arbitrary node in the path corresponding to the fault (such as the transmitting apparatuses A20 and B) (Step S602).

The transmitting apparatus B cancels the control (masking control) under which the management device is not to be notified of an alarm according to the fault recovery information notified by the transmitting apparatus C10 (Step S603). The transmitting apparatus C10 that detects that the fault is recovered cancels the control (masking control) under which the transmitting apparatus C10 does not notify the management device of an alarm (Step S603).

As described above, according to the sixth embodiment, if the transmitting apparatus detects that a fault is recovered in the network, the transmitting apparatus notifies an arbitrary node of recovery information of the fault. The transmitting apparatus that is notified of the fault recovery information cancels the masking control under which the management device is not to be notified of an alarm. As a result, even if a fault occurs again, the transmitting apparatus can flexibly setup a node in which the masking control is performed not to issue an alarm to the management device and a node which notifies the management device of an alarm according to load condition of the network and the like.

That is, the transmitting apparatus performs masking control such that an alarm is not issued to the management device from a node connected to a network continuously under a high load, but is issued from a node connected to a network continuously under a low load. Therefore, the transmitting apparatus can control an alarm according to condition of the network to which the transmitting apparatus is connected. Moreover, the transmitting apparatus can more quickly cancel the masking control of an alarm for the management device.

While specific embodiments have been described, other embodiments or modifications are also possible. In the following, such modifications will be described in relation to (1) alarm control setup for each path, (2) configuration of a transmitting apparatus, (3) an alarm control program, and (4) a message transmitting/receiving program.

Alarm Control Setup for Each Path

In the first to sixth embodiments, examples are described in which, in the entire network or in an arbitrary node, masking control of an alarm for the management device is performed or cancelled. However, when path setup is performed under GMPLS, whether to perform the masking control of an alarm may be specified for each of the paths.

For example, as depicted in FIG. 12, at the time of path setup, a path in which the masking control of an alarm is performed can be decided by using a reserved field of the ADMIN_STATUS object in a path message or in a reserve message. When the masking control of an alarm is performed, the M bit thereof is set to ON “1”. When the masking control is not performed, the M bit is set to OFF “0”. The ADMIN_STATUS object is saved between each two transmitting apparatuses. Therefore, when the masking control of an alarm is performed, whether the masking control of an alarm is performed can be specified by referring to the M bit.

(2) Configuration of the Transmitting Apparatus

The process procedure, the control procedure, specific names, and information including various data and parameters described above and illustrated in the drawings (for example, fault information notified by the “fault information notifying unit 12a” depicted in FIG. 2) can be arbitrarily changed unless otherwise specified.

The constituent elements described above are functionally conceptual, and need not be physically configured as illustrated. In other words, the specific mode of dispersion and integration of the constituent elements is not limited to the ones illustrated in the drawings, and the constituent elements, as a whole or in part, can be divided or integrated either functionally or physically based on various types of loads or use conditions. For example, the fault information notifying unit 12a, the alarm control unit 12b, the alarm generation determining unit 22a, and the message transmitting/receiving unit 22b included in the transmitting apparatuses C10 and A20 may be integrated into a transmitting apparatus having the similar functions. Further, all or arbitrary part of the process functions performed by each device can be implemented by a central processing unit (CPU) and a computer program analyzed and executed by that CPU, or can be implemented as hardware with a wired logic.

(3) Alarm Control Program

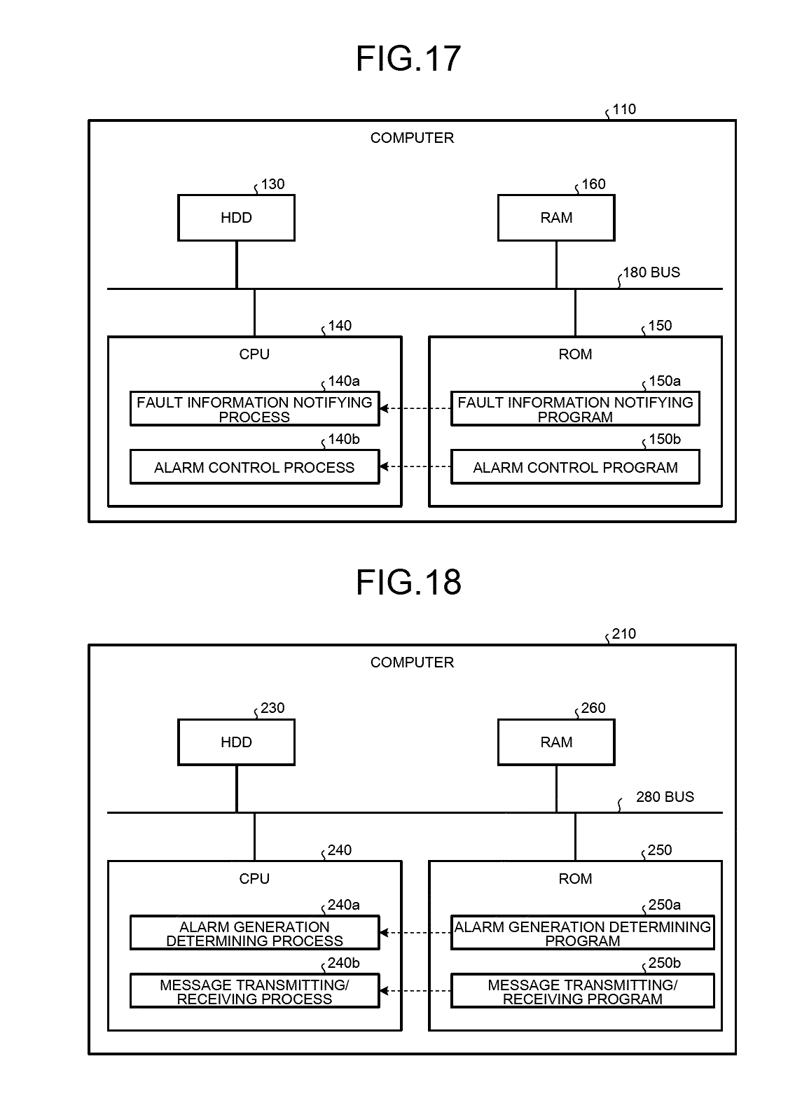

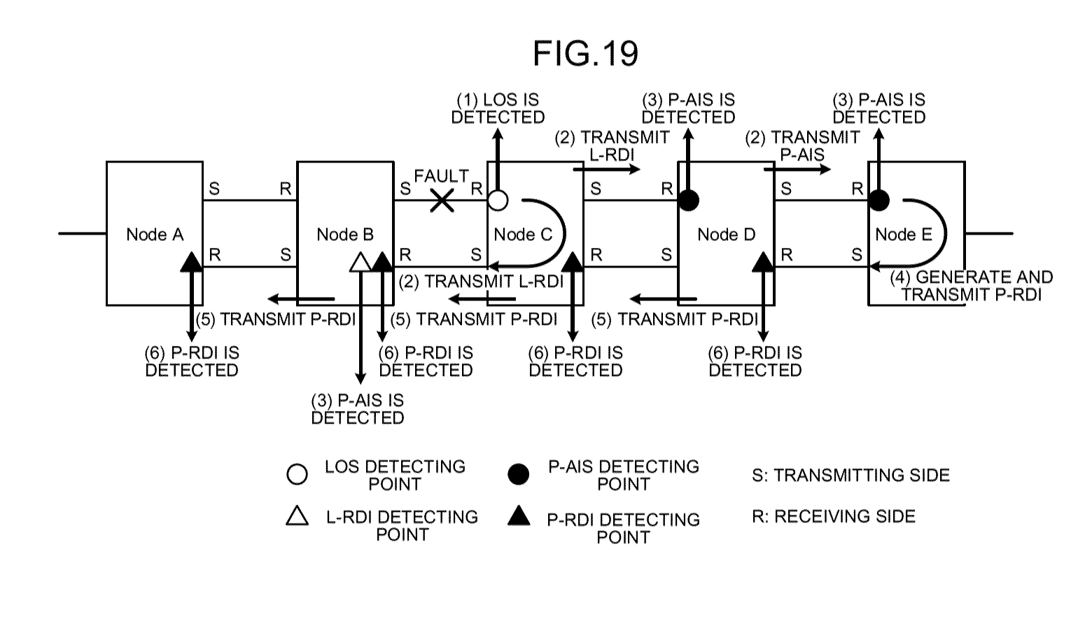

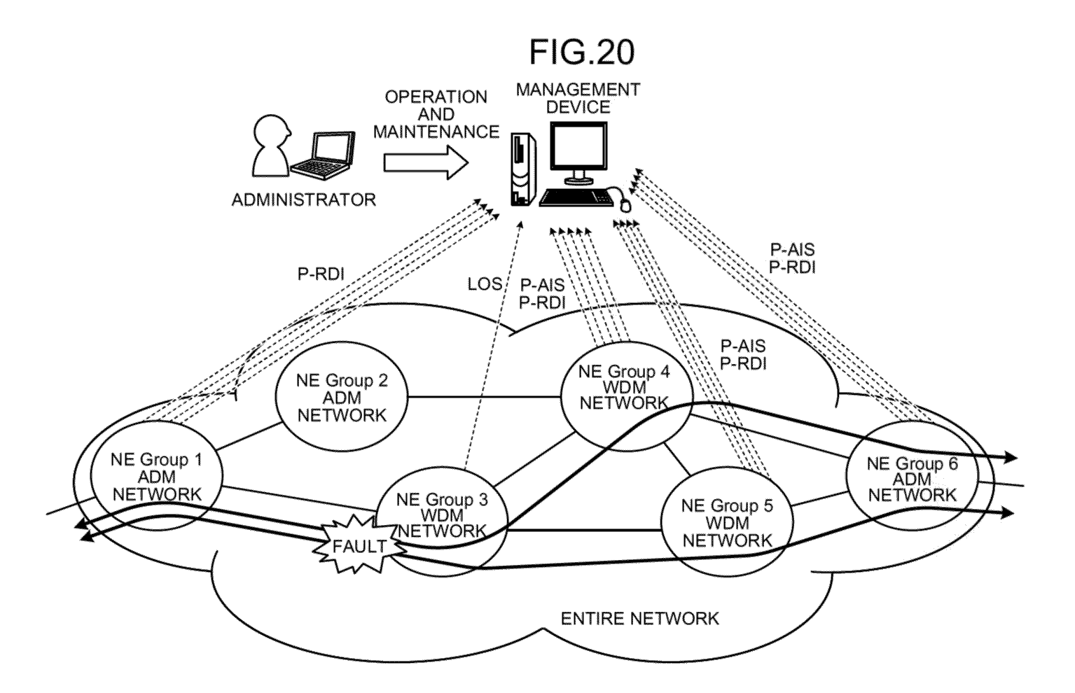

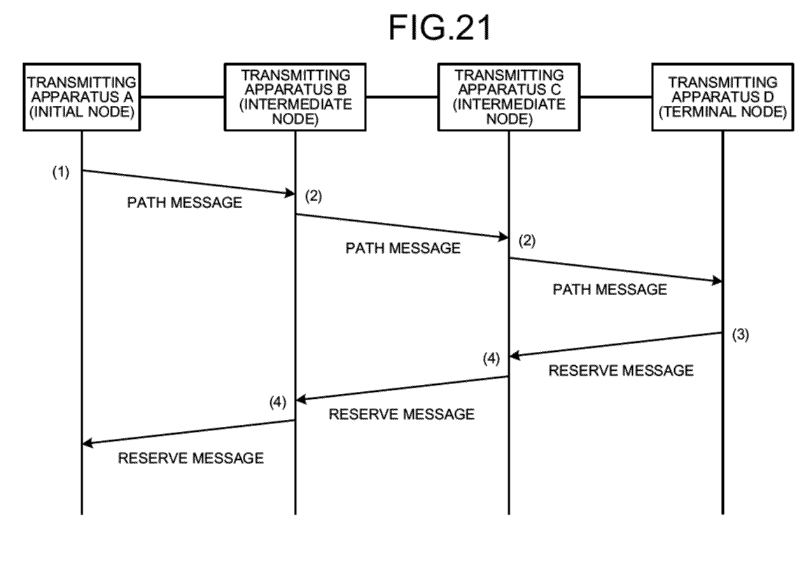

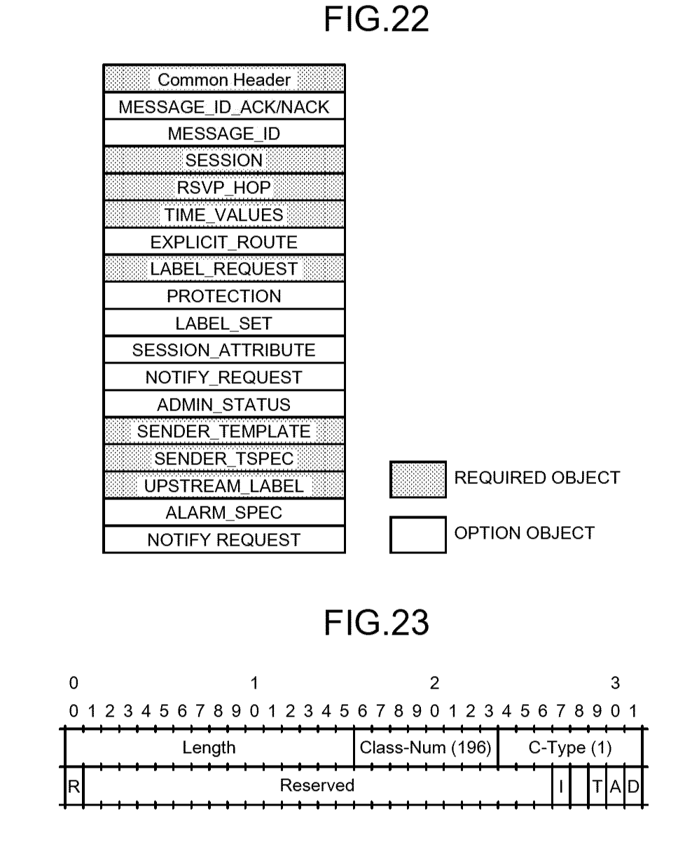

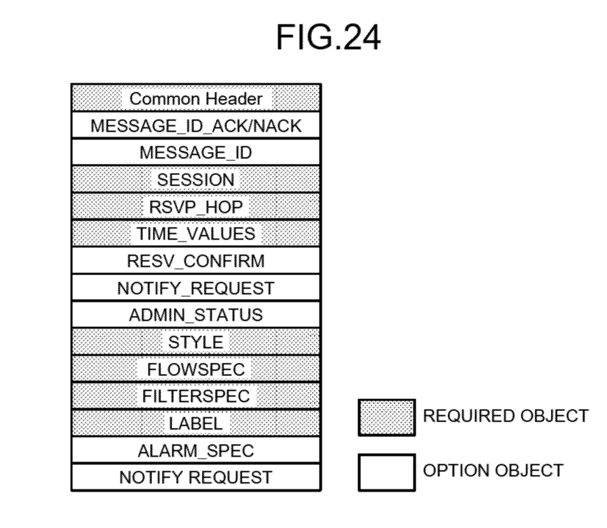

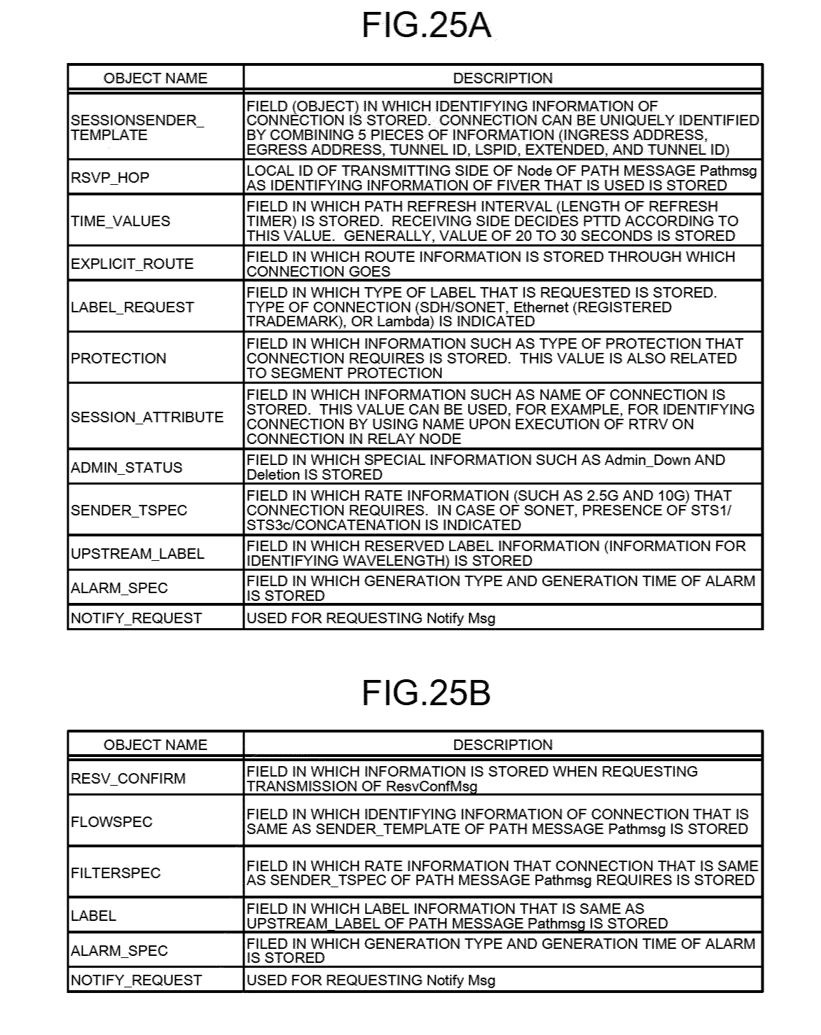

In the embodiment described above, an example is described in which various processes are implemented by hardware logic. However, it is not so limited. The various processes may be implemented by executing a computer program prepared in advance on a computer. With reference to FIG. 17, a description will be given of an example of such a computer that executes a computer program (hereinafter, “alarm control program”) realizing the same function as the transmitting apparatus C described in the above embodiments. FIG. 17 is a diagram of a computer 110 that executes the alarm control program.

As depicted in FIG. 17, the computer 110 that functions as the transmitting apparatus C includes a hard disk drive (HDD) 130, a CPU 140, a read only memory (ROM) 150, and a random access memory (RAM) 160 that are connected to each other via a bus 180 or other devices.

The alarm control program realizing the same function as the transmitting apparatus C10, including a fault information notifying program 150a and an alarm control program 150b, is stored in the ROM 150 in advance. Similar to respective elements of the transmitting apparatus C10 depicted in FIG. 2, the programs 150a and 150b may be dispersed or integrated as appropriate.

The CPU 140 reads the programs 150a and 150b from the ROM 150 and executes them, and thus, the programs 150a and 150b function as a fault information notifying process 140a and an alarm control process 140b as depicted in FIG. 17. The processes 140a to 140b correspond to the fault information notifying unit 12a and the alarm control unit 12b depicted in FIG. 2.

The CPU 140 executes the alarm control program according to the data stored in the HDD 130.

The programs 150a and 150b need not necessarily stored in the ROM 150 in advance. For example, the programs may be stored in a “portable physical medium” such as a flexible disk (FD), a compact disc-read only memory (CD-ROM), a digital versatile disk (DVD) disk, an magnetic optical disk, and an integrated circuit (IC) card that are inserted into the computer 110, a “fixed physical medium” such as a HDD provided in or out of the computer 110, or “another computer (server)” connected to the computer 110 via a public line, the Internet, a local area network (LAN), or a wide area network (WAN), and the computer 110 may read each program therefrom and execute the program.

(4) Message Transmitting/Receiving Program

In the embodiment described above, an example is described in which various processes are implemented by hardware logic. However, it is not so limited. The various processes may be implemented by executing a computer program prepared in advance on a computer. With reference to FIG. 18, a description will be given of an example of such a computer that executes a computer program (hereinafter, “message transmitting/receiving program”) realizing the same function as the transmitting apparatus A described in the above embodiments. FIG. 18 is a diagram of a computer 210 that executes the message transmitting/receiving program.

As depicted in FIG. 18, the computer 210 that functions as the transmitting apparatus A includes an HDD 230, a CPU 240, a ROM 250, and a RAM 260, which are connected to each other via a bus 280 or other devices.

The ROM 250 stores a message transmitting/receiving program 250b realizing the same function as the transmitting apparatus A described in the first embodiment. That is, The ROM 250 stores in advance an alarm generation determining program 250a and the message transmitting/receiving program 250b as depicted in FIG. 18. Similar to the constituent elements of the transmitting apparatus A20 depicted in FIG. 3, the programs 250a and 250b may be dispersed or integrated as appropriate.

The CPU 240 reads the programs 250a and 250b from the ROM 250 and executes them. Thus, the programs 250a and 250b function as an alarm generation determining process 240a and a message transmitting/receiving process 240b, respectively. The processes 240a and 240b correspond to the alarm generation determining unit 22a and the message transmitting/receiving unit 22b depicted in FIG. 3, respectively.

The CPU 240 executes the message transmitting/receiving program 250b according to the data stored in the HDD 230.

The programs 250a and 250b need not necessarily stored in the ROM 250 in advance. For example, the programs may be stored in a “portable physical medium” such as a flexible disk (FD), a CD-ROM, a DVD disk, an magnetic optical disk, and an IC card, which are connectable to the computer 210. The programs may also be stored in a “fixed physical medium” such as an HDD provided inside or outside the computer 210. Further, the programs may also be stored in “another computer (server)” connected to the computer 210 via a public line, the Internet, a LAN, or a WAN, and so that the computer 210 can read each program therefrom and execute the program.

As set forth hereinabove, according to an embodiment, a transmitting apparatus can reduce a load of maintenance work performed by the system administrator that operates a network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A transmitting apparatus that is connected to a management device that manages a network and transfers data, the transmitting apparatus comprising:
a fault information notifying unit that, when detecting occurrence of a fault in the network, notifies an initial node in a path corresponding to the fault of fault information including information about the fault; and
an alarm control unit that, when receiving a message communicated between the initial node having received the fault information from the fault information notifying unit and a terminal node, the message including alarm masking information that prevents an alarm to notify the management device of occurrence of the fault from being issued to the management device, controls the alarm not to be issued to the management device based on the alarm masking information.

2. The transmitting apparatus according to claim 1, wherein
the fault information notifying unit notifies an arbitrary node in the path of the fault information, and
the alarm control unit controls the alarm not to be issued to the management device based on the fault information notified by a node that has detected the occurrence of the fault in the network.

3. The transmitting apparatus according to claim 1, further comprising an alarm notification control unit that controls the alarm not to be generated until the alarm control unit controls the alarm not to be issued to the management device.

4. The transmitting apparatus according to claim 1, further comprising a storage unit that stores therein alarm notifying information about whether to issue the alarm to the management device, wherein
the alarm control unit controls whether to issue the alarm to the management device based on the alarm masking information and the alarm notifying information.

5. The transmitting apparatus according to claim 1, wherein
when detecting that the fault is recovered in the network, the fault information notifying unit notifies the initial node in the path of fault recovery information including information on recovery of the fault, and
when receiving a message communicated between the initial node having received the fault recovery information from the fault information notifying unit and the terminal node, the message including the fault recovery information, the alarm control unit cancels control under which the alarm is not to be issued to the management device based on the fault recovery information.

6. The transmitting apparatus according to claim 5, wherein
the fault information notifying unit notifies an arbitrary node in the path of the fault recovery information, and
the alarm control unit cancels the control under which the alarm is not to be issued to the management device based on the fault recovery information notified by the node that detects that the fault has been recovered in the network.

7. A transmitting apparatus that is connected to a management device that manages a network and transfers data, the transmitting apparatus comprising:
an alarm generation determining unit that, when detecting occurrence of a fault in the network or notified of information on occurrence of a fault from another transmitting apparatus, determines whether an alarm that notifies the management device of the occurrence of the fault is generated by a plurality of nodes in a path corresponding to the fault; and
a message transmitting/receiving unit that, when the alarm generation determining unit determines that the alarm is generated, communicates a message including alarm masking information that suppresses the alarm between the transmitting apparatus and a terminal node via an intermediate node in the path.

8. The transmitting apparatus according to claim 7, further comprising an alarm notification setup unit that sets whether to issue the alarm to the management device for each path.

9. An alarm control method applied to a transmitting apparatus that is connected to a management device that manages a network and transfers data, the alarm control method comprising:
notifying, upon detecting occurrence of a fault in the network, an initial node in a path corresponding to the fault of fault information including information about the fault;
determining, when the initial node receives the fault information, whether an alarm that notifies the management device of the occurrence of the fault is generated by a plurality of nodes in the path corresponding to the fault;
communicating, when it is determined that the alarm is generated at the determining, a message including alarm masking information that suppresses the alarm between the initial node and a terminal node via an intermediate node in the path; and
controlling, upon receipt of the message, the alarm not to be issued to the management device based on the alarm masking information.

10. A computer readable storage medium containing instructions that, when executed by a computer as a transmitting apparatus that is connected to a management device that manages a network and transfers data, causes the computer to perform:
determining, upon detecting occurrence of a fault in the network or being notified of information on occurrence of a fault from another transmitting apparatus, whether an alarm that notifies the management device of the occurrence of the fault is generated by a plurality of nodes in a path corresponding to the fault; and
communicating, when it is determined that the alarm is generated at the determining, a message including alarm masking information that suppresses the alarm between the transmitting apparatus and a terminal node via an intermediate node in the path.
